(19) United States
(12) Patent Application Publication
(10) Pub. No.: US 2026/0128244 A1
(43) Pub. Date: May 7, 2026

(54) DUAL ACTUATION FAST MECHANICAL SWITCH

(71) Applicant: GEORGIA TECH RESEARCH CORPORATION, Atlanta, GA (US)

(72) Inventors: Alfonso J. CRUZ, Atlanta, GA (US); Ning GUO, Atlanta, GA (US); Lukas GRABER, Atlanta, GA (US); Zhiyang JIN, Atlanta, GA (US); Yang LIU, Atlanta, GA (US); Maryam TOUSI, Atlanta, GA (US)

(21) Appl. No.: 19/117,889

(22) PCT Filed: Oct. 20, 2023
(86) PCT No.: PCT/US2023/077407

§ 371 Date: Apr. 2, 2025

Related U.S. Application Data
(60) Provisional application No. 63/380,304, filed on Oct. 20, 2022.

(51) Int. Cl. H01H 33/28; H01H 3/32; H01H 9/24; H01H 9/52; H01H 33/02; H01H 33/53

(52) U.S. Cl. CPC H01H 33/28; H01H 3/32; H01H 9/24; H01H 33/53; H01H 2009/523; H01H 2033/028

(57) ABSTRACT

The exemplary systems, methods, and devices of the present disclosure include a dual actuation mechanical switch for a circuit breaker that includes a piezoelectric actuator that operates in conjunction with a second mechanical actuator, e.g., for a fast, compact, lightweight, and efficient DC hybrid circuit breaker. In some implementations, the exemplary dual mechanical switch can serve as the only current carrying path of the circuit breaker to minimize on-state power loss during normal operation. The exemplary system, method, and devices can facilitate needs of the emerging DC grid.

### CROSS-REFERENCE TO RELATED APPLICATIONS

This application claims priority to U.S. Provisional Ser. No. 63/380,304 , filed Oct. 20, 2022, which is incorporated herein by reference in its entirety.

### STATEMENT REGARDING FEDERALLY SPONSORED RESEARCH OR DEVELOPMENT

This invention was made with government support under Grant No. AWD-002133 awarded by the Advanced Research Projects Agency-Energy Department of Energy. The government has certain rights in the invention.

### TECHNICAL FIELD

The present disclosure relates, generally, to electric power systems. More specifically, it relates to mechanical switches, e.g., transfer or disconnect switches, in a circuit breaker.

### BACKGROUND

A transfer switch is an electrical component configured to transfer loads between electrical connections. Existing fast transfer switches have been developed based on Thomson coils, power electronics, propellant-based systems, or coupled electromechanical and hydraulic systems, each of the foregoing having some technical trade-offs. Thomson coils require high current pulses. Other components can employ power electronics switches that can have significant conduction losses. Yet other components may be propellant-based and thus cannot be automatically reset. Other hybrid electromechanical and hydraulic systems are complex and slow.

For conventional disconnect switch applications where non-current-carrying electrical conductors are physically moved to achieve separation from each other, thus creating electrical isolation, coupled mechanical systems can be used to separate the contacts sufficiently so that the breakdown voltage of the contact gap is sufficient for the application. This contact separation can be conventionally achieved by an indirect application of force through a series of levers or via the direct application of force with the contacts, e.g., enclosed in a vacuum or pressurized gas medium (called the switching chamber), or via a combination of the two approaches. Trade-offs of these methods include the speed, particularly for fast and high voltage applications, e.g., medium voltage (1 kV-69 kV) switching applications. Such types of disconnect switches are being considered for hybrid power electronics. Furthermore, large, slow circuit breakers are typically used to handle high-magnitude fault currents in a system.

There is a benefit to improving disconnect/transfer switches.

### SUMMARY

The exemplary systems, methods, and devices of the present disclosure include a dual actuation mechanical switch for a circuit breaker that includes a piezoelectric actuator that operates in conjunction with a second mechanical actuator, e.g., for a fast, compact, lightweight, and efficient DC hybrid circuit breaker. In some implementations, the exemplary dual mechanical switch can serve as the only current-carrying path of the circuit breaker to minimize on-state power loss during normal operation. The exemplary system, method, and devices can facilitate the needs of the emerging DC grid.

During an example normal operation, the piezoelectric actuator and second mechanical actuator (e.g., stepper motor) are energized to make contact and effectively close a circuit, allowing current flow, and, during an example tripping event, the piezoelectric actuator and the second mechanical actuator operates simultaneously to break the connection. The piezoelectric actuator can respond within several hundreds of a microsecond, while, at the same time, the second mechanical actuator (e.g., stepper motor) can enlarge the gap distance between the two contact plates, effectively increasing the basic impulse level to more than 100 kV within 1 to 2 seconds, as observed in certain configurations. The ultrafast disconnect/transfer operation can be made straightforward (with few moving components) and compact while operating without high energy requirements or loss. The system can automatically reset to provide effective control.

In some implementations, the exemplary systems, methods, and devices are implemented in a high-pressure vessel to improve the material's coefficient of thermal expansion for elevated temperature operation. The pressure vessel can retain supercritical fluids (SCF) as a dielectric medium that can enhance voltage breakdown capabilities while also being able to carry several kiloamperes of continuous current.

In one aspect, a system is disclosed, the system including: a first conductive structure (e.g., piezoelectric device housing) electrically connected to a first electrical terminal to receive high current and high voltage. The system further includes a first movable contact structure moveably connected to the first conductive structure and configured to move between a first position and a second position each in relation to the first conductive structure while in electrical contact with the first conductive structure. The system further includes a second contact structure (e.g., stationary or movable) electrically connected to a second electrical terminal configured to handle high current and high voltage. The first movable contact structure is in contact with the second contact structure when in the first position, and the first movable contact structure is disconnected from the second contact structure when in the second position. The system further includes a first actuation assembly (e.g., piezoelectric actuators) disposed within the first conductive structure and mechanically coupled to the first movable contact structure to move the first movable contact structure, along a first direction, between the first position and the second position when energized or de-energized, respectively, to connect or disconnect the first movable contact structure to the second contact structure. The system further includes a second actuation assembly (e.g., having stepper motor, linear motor, servo motor, piezoelectric assembly) either (i) mechanically coupled to the first actuation assembly within the first conductive structure to concurrently move the first movable contact structure from the first position to the second position, or (ii) mechanically coupled to the second contact structure within a second conductive structure to concurrently move the second contact structure to a third position further away from the first movable contact structure.

In some implementations, the first actuation assembly moves the first movable contact structure to the first position when energized, and the first actuation assembly moves the first movable contact structure from the first position to the second position to break contact with the second contact structure when de-energized. In some implementations, the second actuation assembly is disposed within the first conductive structure and is mechanically coupled to the first actuation assembly, wherein the second actuation assembly moves the first movable contact structure in part from the first position to the second position.

In some implementations, the second actuation assembly is disposed within the second conductive structure and moves the second contact structure to the third position, to further extend a separation distance between the first movable contact structure and the second contact structure.

In some implementations, the second actuation assembly moves the second contact structure in response to a thermal expansion to (i) ensure adequate electrical connection between the first and second contact structures in the first position, and (ii) ensure an adequate separation distance between the first and second contact structures in the second and third positions.

In some implementations, the first actuation assembly has a first longitudinal axis corresponding to the first direction, wherein the second actuation assembly has a second longitudinal axis colinear to the first longitudinal axis. In some implementations, a separation distance between the first movable contact structure and the second contact structure provides insulation of at least 100 kV. In some implementations, the first and second contact structures together form an opposing piston arrangement.

In some implementations, the system further includes an outer housing that surrounds the first movable contact structure and the second contact structure. The outer housing is an enclosed vessel to surround the first conductive structure, the first movable contact structure, and the second contact structure and encloses a dielectric fluid. In some implementations, the outer housing includes an insulative material (e.g., ceramic or composite material). In some implementations, the outer housing is a pressure vessel configured to house supercritical fluids as a dielectric medium. In some implementations, the outer housing includes one or both of (i) welded seams and (ii) bolts extending through a side portion of the outer housing to seal a supercritical fluid within an inner cavity defined by the outer housing.

In some implementations, the system further includes a third actuation assembly located in the second conductive structure, the third actuation assembly coupled to the second contact structure.

In some implementations, the first actuation assembly includes a plurality of piezoelectric devices arranged in at least one stack, and the second actuation assembly includes a servo motor, linear stepper motor, or a hydraulic system.

In some implementations, the system further includes a heat exchange system, including a pipe (e.g., copper pipe) disposed partially within the outer housing and partially outside of the outer housing via a heat exchanger opening defined by a sidewall of the outer housing. The heat exchange system further includes a heat exchanger disposed adjacent to the outer housing and a pump in fluid communication with the pipe, the pump is configured to move a control fluid (e.g., water or coolant) through the pipe between the heat exchanger and the outer housing.

In some implementations, a signal to de-energize the first actuation assembly to move the first movable contact structure from the first position to the second position to break contact with the second contact structure is triggered by a 0V or near-zero voltage condition across the first and second contact structures (e.g., to avoid arcing).

In some implementations, the system further includes a controller coupled to the first and second actuation assemblies and configured to de-energize the first actuation assembly to move the first movable contact structure from the first position to the second position to break contact with the second contact structure. A signal for the controller to de-energize the first actuation assembly is triggered by a 0V or near-zero voltage condition across the first and second actuation assemblies (e.g., to avoid arcing). In some implementations, the controller energizes or de-energizes each of the first actuation assembly and the second actuation assembly concurrently based on the signal.

In some implementations, the system is configured as an AC power circuit breaker or a DC power circuit breaker.

In another aspect, a method to operate a disconnect switch is disclosed, the method including: providing the system; and energizing the first actuation assembly to put the disconnect switch in a connected state.

In yet another aspect, a method of operating a disconnect switch is disclosed, the method including: providing a disconnect system including: a first conductive structure electrically connected to a first electrical terminal to receive high current and high voltage; a first movable contact structure movably connected to the first conductive structure and configured to move between a first position and a second position each in relation to the first conductive structure while in electrical contact with the first conductive structure; a second contact structure (stationary or movable) electrically connected to a second electrical terminal configured to handle high current and high voltage, wherein the first movable contact structure is in contact with the second contact structure in the first position and wherein the first movable contact structure is disconnected from the second contact structure when in the second position; a first actuation assembly disposed within the first conductive structure and mechanically coupled to the first movable contact structure to move the first movable contact structure, along a first direction, between the first position and the second position when energized or deenergized, respectively, to connect or disconnect the first movable contact structure to the second contact structure; and a second actuation assembly (having stepper motor, linear motor, servo motor, piezoelectric assembly) either (i) mechanically coupled to the first actuation assembly within the first conductive structure, or (ii) mechanically coupled to the second contact structure within a second conductive structure; initiating a zero or near-zero voltage potential difference across the first and second contact structures; de-energizing the first actuation assembly to move the first movable contact structure from the first position to the second position to break contact with the second contact structure; and energizing the second actuation assembly to concurrently move either (i) the first movable contact structure from the first position to the second position to further extend a separation distance between the first movable contact structure and the second contact structure, or (ii) the second contact structure to a third position further away from the first movable contact structure.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIGS. 1A-1G show diagrams of exemplary mechanical disconnect switches and systems, according to various implementations.

FIG. 2 provides a block diagram describing a method of disconnected electrical terminals using a system or device of the present disclosure, according to one implementation.

FIGS. 3A-3D show views of another exemplary mechanical disconnect switch system, according to one implementation.

FIGS. 4A-4E show views of another exemplary mechanical disconnect switch system, according to one implementation.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, fast mechanical disconnect/transfer switches are shown, according to various implementations.

### EXAMPLE SYSTEMS

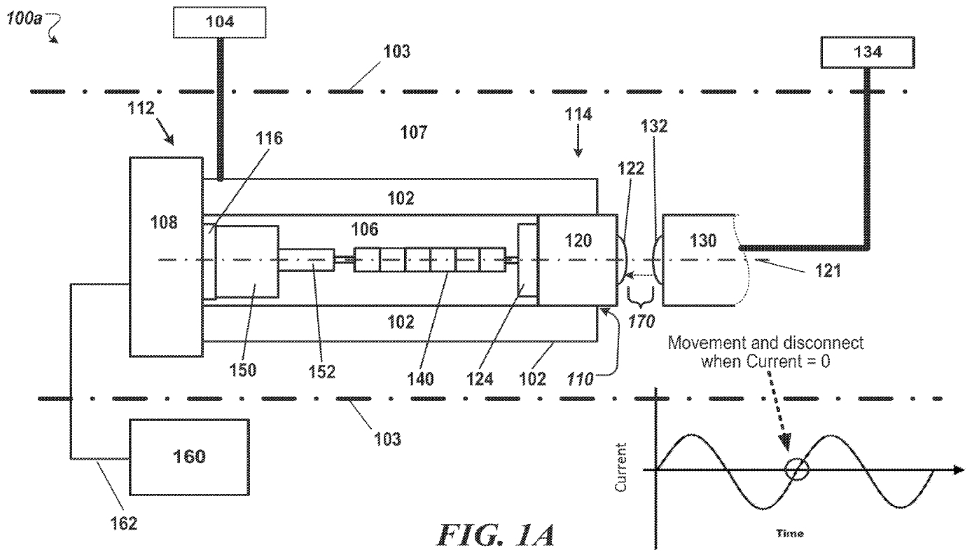

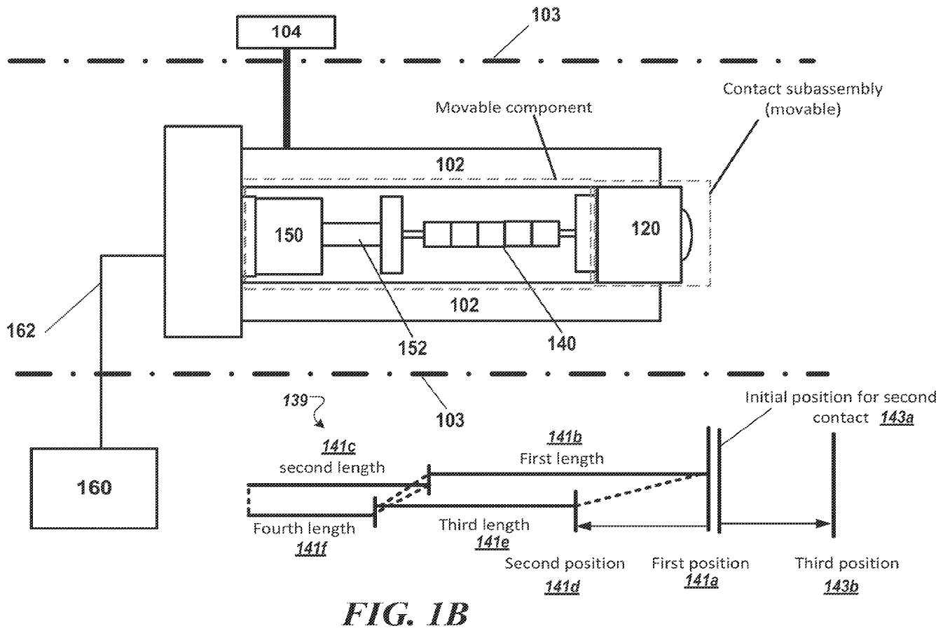

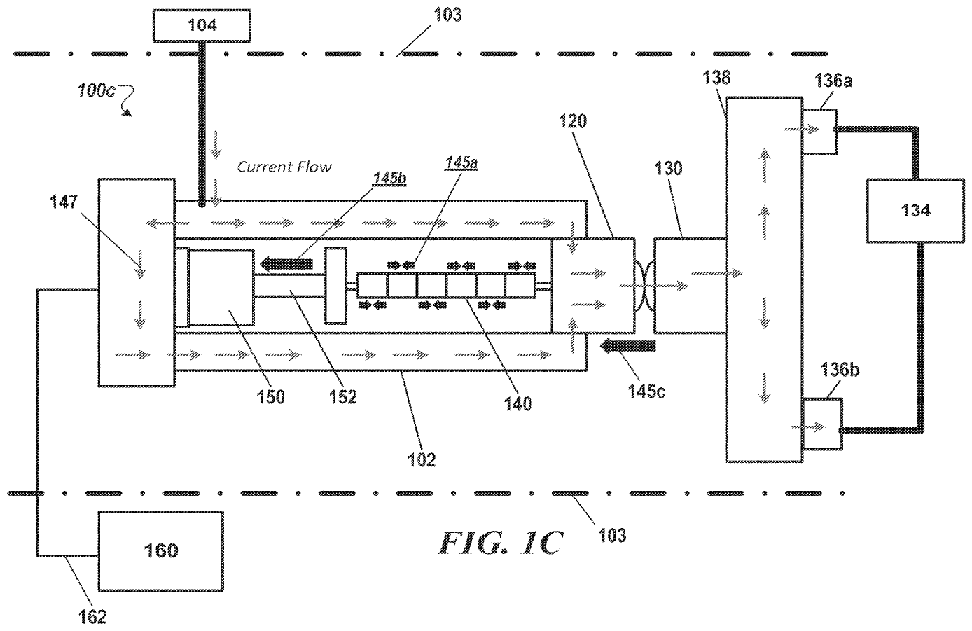

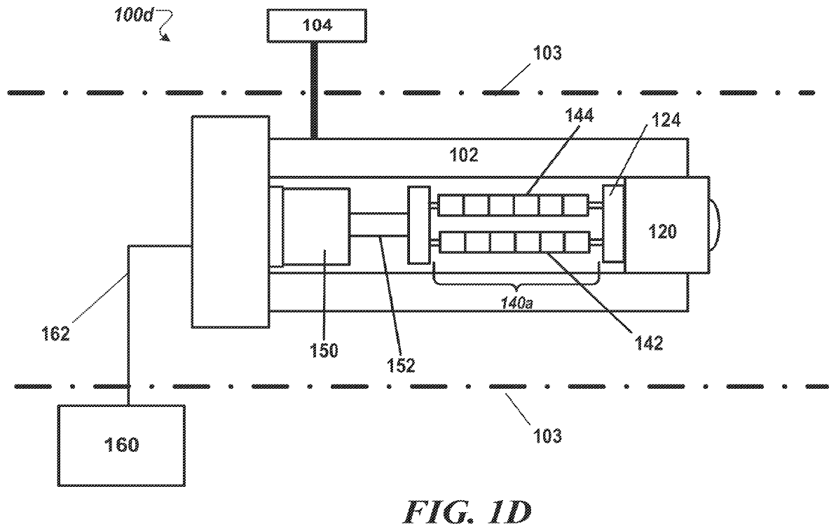

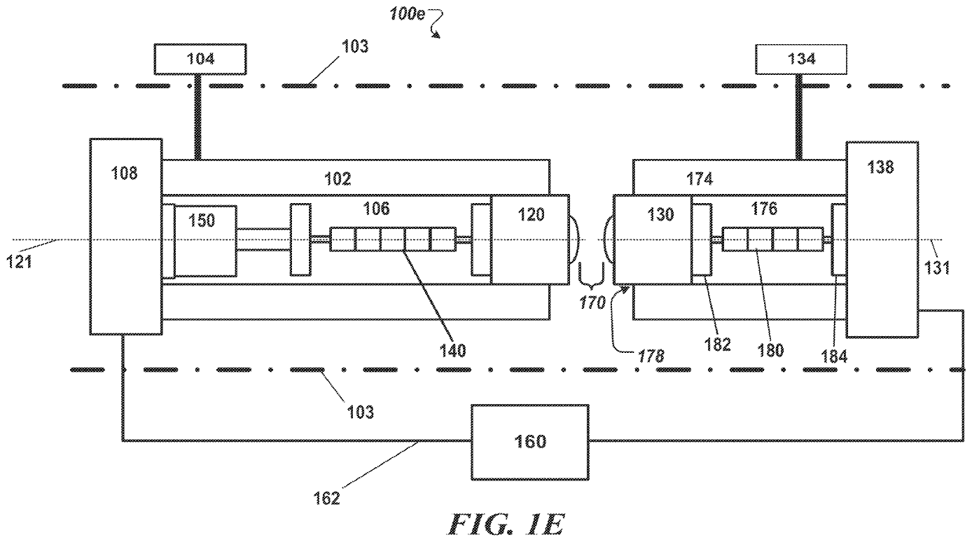

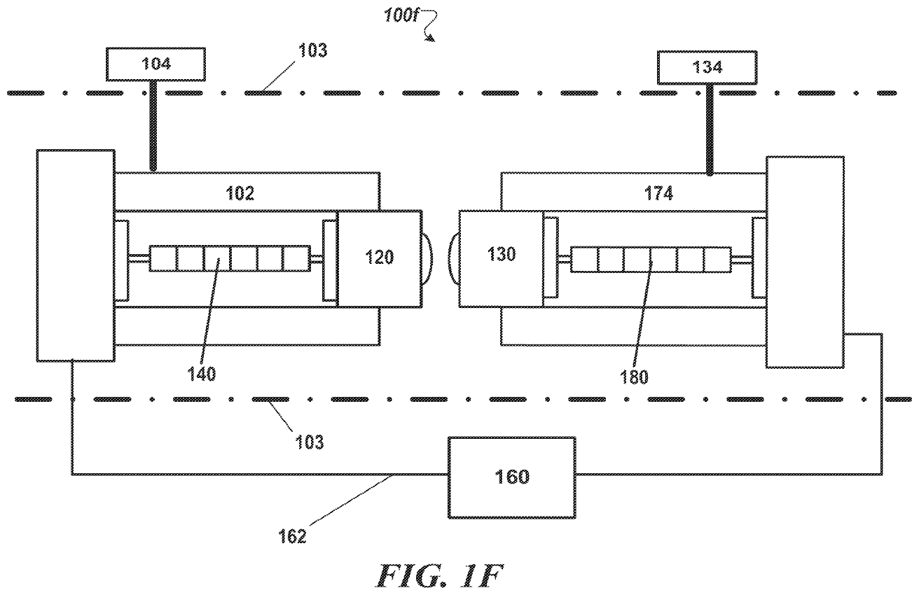

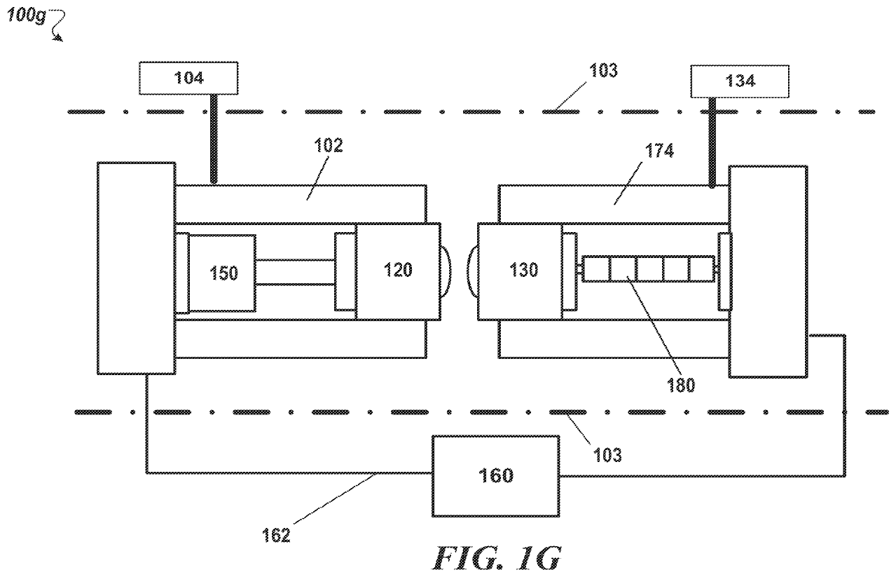

FIGS. 1A-1G show a number of embodiments of a dual actuation fast mechanical switch 100. Each of the shown embodiments provides an example, and the set of provided examples are not meant to be inclusive of all possible embodiments contemplated by the present disclosure.

FIGS. 1A and 1B show diagrams (e.g., a cross-sectional diagram) of a first example of a dual actuation fast mechanical switch system 100 (shown as 100a) according to one implementation. FIGS. 1C, 1D, 1E, and 1F respectively shows a second, third, fourth, and fifth example of the dual actuation fast mechanical switch system 100 (shown as 100c, 100d, 100e, 100f).

Example #1. In the example of FIG. 1A, the system 100a includes a first conductive structure 102, a first contact structure 120, a second contact structure 130, a first actuation assembly 140, and a second actuation assembly 150 that is located within a vessel/housing 103 (shown by lines 103). The vessel/housing 103 and associated structure are electrical grounded. The system 100a is movable between (i) a connected state wherein electricity may flow between the first contact structure 120 and the second contact structure 130 through the internal structure within the vessel/housing 103 and (ii) a disconnected state where the first contact structure 120 and the second contact structure 130 are separated by a distance such that electricity is hindered from flowing therebetween.

The first conductive structure 102 of the internal structure is electrically connected to a first electrical terminal 104 (e.g., a high voltage connection) to receive current/voltage (e.g., high current and high voltage). The first conductive structure 102 is a structure (e.g., cylindrical structure) having conductive sidewalls to define an inner cavity 106. As shown, the first conductive structure 102 is coupled to a mounting block 108 (e.g., an electrical mounting block, a mechanical mounting block, or a combination of both functions) on a proximal end 112. A first insulating member 116 is coupled to the mounting block 108 within the inner cavity 106 to electrically isolate the second actuation assembly 150 from the mounting block 108. The first conductive structure 102 defines an opening 110 on a distal end 114 sized to accommodate the first contact structure 120.

The first contact structure 120 is movably connected to the first conductive structure 102 (e.g., in electrical and mechanical communication with the first conductive structure 102). The contact structure 120 is sized to form a seal with the conductive structure 102 (sidewalls) while also allowing movements in relation to the conductive structure 102. The first contact structure 120 includes a distally located contact protrusion 122 extending outward from the first contact structure 120. The first contact structure 120 further includes a second insulating member 124 disposed on a proximal or “back” side of the first contact structure 120 within the inner cavity 106 of the first conductive structure 102. The second insulating member 124 electrically isolates the first contact structure 120 on the “back” side from the first actuation assembly 140.

As shown in FIG. 1A, the first contact structure 120 slidably contacts the first conductive structure 102 around the opening 110 (e.g., circular opening) and on the inner surface adjacent the inner cavity 106. While in electrical contact with the first conductive structure 102, the first contact structure 120 is configured to move between a first position and a second position (see, e.g., FIG. 1B) along a first longitudinal axis 121 of the first contact structure 120. The first position of the first contact structure 120 is defined as being distally located further away from the mounting block 108 along the first longitudinal axis 121 than the second position of the first contact structure 120. For example, the first position of the first contact structure 120 corresponds to the connected state of the system, e.g., illustrated by system 100c in FIG. 1C. The second position of the first contact structure 120 corresponds to the disconnected state of the system 100a shown in FIG. 1A.

In the example shown in FIG. 1A, the second contact structure 130 is configured to be stationary and electrically connected to a second electrical terminal 134 (e.g., a high voltage connection) to handle high current and high voltage. In other implementations, the second contact structure is movable between a third and fourth position in a similar manner as the first contact structure. The second contact structure 130 includes a distally located contact protrusion 132 extending outward from the second contact structure 130. The second contact structure 130 includes a second longitudinal axis 131 that is colinear with the first longitudinal axis 121 of the first contact structure 120.

The first actuation assembly 140 and the second actuation assembly 150 of the system 100a are each located in the inner cavity 106 of the first conductive structure 102. The first actuation assembly 140 and the second actuation assembly 150 are coupled between the first insulating member 116 and the second insulating member 124 to electrically isolate each of the actuation assemblies from the electrically conductive portions of the system (e.g., the first contact structure 120 and the first conductive structure 102).

In some embodiments, the inner cavity 106 is filled with a dielectric fluid and is in pressure equilibrium with the cavity 107 formed by the vessel/housing 103. That is, in configurations in which the inner cavity 106 is filled with a dielectric fluid/gas (e.g., non-conductive oil/fluid, nitrogen gas, or other inert dielectric gas), the cavity 107 on the side of the conductive structure 102 is also filled with the dielectric fluid to minimize pressure differential between the two cavities to allow the contacts 120, 130 to move without resistance from such pressure differential. In other embodiments, the cavities 106, 107 may be in vacuum or filled with air (or other dielectric fluid or gas described herein) at reduced pressure. In yet other embodiments, the assembly 140 and 150 may be employed without a housing/vessel 103.

In the example shown in FIG. 1A, the first actuation assembly 140 includes a piezoelectric actuator stack. The piezoelectric stack of assembly 140, in the example shown in FIG. 1A, includes five distinct piezoelectric actuators that are linked/coupled to each other and are configured to mechanically deform/actuate together in the first and second direction along the first longitudinal axis 121. In other implementations, the piezoelectric actuator stack may include 1, 2, 3, or 4 actuators or more than 5 actuators (e.g., 6, 7, 8, 9, 10, 15, 20, 30, 40, or more). In yet other implementations, more than one piezoelectric actuator stacks are used to form the first actuation assembly (e.g., see FIG. 1D).

The first actuation assembly 140 is coupled to the first contact structure 120 to move the first contact structure 120 in the first direction along the first longitudinal axis 121. For example, the first actuation assembly 140 may be energized to expand the piezoelectric stack of assembly 140 to a first overall length such that the first contact structure 120 is in the first position. Then, when deenergized, the piezoelectric stack will compress to move the first contact structure 120 along the first direction away along the first longitudinal axis 121 and away from the second contact structure 130 (e.g., towards or to the second position).

The second actuation assembly 150 of the system 100a shown in FIG. 1A is a motor (e.g., stepper motor, linear motor, servo motor, etc.). However, in other implementations, the second actuation assembly may comprise a piezoelectric stack or some other device configured for linear motion (e.g., hydraulic actuators). The second actuation assembly 150 is coupled to the first actuation assembly 140 on one side and to the mounting block 108 via the first insulating member 116 on the other side. The second actuation assembly 150 includes a connecting member 152 to facilitate the connection to the first actuation assembly 140. The connecting member 152 may be the shaft of a motor of the second actuation assembly 150 configured to extend or contract along the first longitudinal axis 121 when energized or deenergized (e.g., to a first or second polarity).

The system 100a further includes a controller 160 coupled to and in electrical communication with the first actuation assembly 140 and second actuation assembly 150 via wiring 162. The controller 160 is configured to control the operation of the first actuation assembly 140 and second actuation assembly 150 (e.g., to activate/deactivate each to facilitate movement of the first contact structure 120 between the first and second positions). The controller 160 may also be coupled to a centralized controller (e.g., a hybrid circuit breaker system of a DC power transfer station). In some implementations, the controller 160 further includes sensors configured to detect the current and/or voltage flow through the system.

Although the controller 160 is shown outside of the vessel/housing 103, it is contemplated that certain embodiment of the controller 106 could be implemented, in whole or part, within the housing or vessel.

During operation, the first contact structure 120 is in a first position with respect to the second contact structure 130 such that the distally located contact protrusion 122 of the first contact structure first contact structure 120 contacts and forms and electrical connection with the distally located contact protrusion 132 of the second contact structure 130. In the first position, the first actuation assembly 140 is energized to mechanically deform and expand the piezoelectric stack, and the second actuation assembly 150 is energized to a first polarity to extend the connecting member 152. Thus, the system 100a is in the connected state wherein voltage may flow from the first electrical terminal 104, through the first conductive structure 102, through the first contact structure 120, through the second contact structure 130, and to the second electrical terminal 134.

To disconnect the electrical connection between the first electrical terminal 104 and the second electrical terminal 134, the system 100a is configured for fast mechanical actuation to form a gap 170 between the contact protrusion 122 of the first contact structure 120 and the contact protrusion 132 of the second contact structure 130. The gap 170 is formed by moving the first contact structure 120 from the first position to the second position along the first longitudinal axis 121.

To move from the connected state to the disconnected state, the controller 160 sends a signal to the first actuation assembly 140 and the second actuation assembly 150. This signal is sent when the detected voltage between the two assemblies is at or close to 0V (e.g., as detected by a sensor in the controller 160 or as detected and transmitted by a separate electrical component or system). The 0V state avoids arcing when moving between the connected and disconnected states.

The signal from the controller 160 causes each of the first actuation assembly 140 and second actuation assembly 150 to concurrently activate to move in a first direction away from the second contact structure 130 (e.g., de-energizing the piezoelectric stack and energizing the motor to a second or changed polarity). The first actuation assembly 140 is configured as an ultrafast first step in the disconnection due to the quick activation of the piezoelectric actuators. Upon de-energization, the piezoelectric actuator stack deforms to contract to a second overall length that is smaller than the first overall length, breaking contact with the second contact structure 130. Thus, a small gap 170 is formed between the distally located contact protrusion 132 and the distally located contact protrusion 122. An ultrafast disconnection is accomplished; however, the gap 170 is still too small to adequately electrically isolate the first contact structure 120 and the second contact structure 130. The second actuation assembly 150 is then used to expand the gap 170 and the associated separation distance between the first contact structure 120 and the second contact structure 130.

Concurrently, the second actuation assembly 150 moves from a first length in the first position to a second length in the second position that is shorter than the first length. Upon energization to a second polarity, the motor of the second actuation assembly 150 contracts the connecting member 152. This motion moves the distally located contact protrusion 122 further away from the second contact structure 130, expanding the gap 170 to an adequate separation distance to isolate each contact structure from the other. In some implementations, the gap 170 provides an insulation of at least 100 kV.

In some implementations, the second actuation assembly 150 is configured to adjust the location of the first contact structure 120 with respect to the second contact structure 130 based on the thermal expansion of an element of the system 100a. For example, in high-temperature scenarios, the first actuation assembly 140, the second actuation assembly 150, and the first contact structure 120 may expand to increase contact with the second contact structure 130 or reduce the gap 170 therebetween. Such thermal expansion may prevent the system 100a from adequately isolating or contacting the first and second contact structures 120, 130. Thus, the second actuation assembly 150 may extend or retract, placing the first contact structure 120 at a newly calibrated first or second position. The calibration and/or adjustments may be facilitated by the controller 160 and associated signals sent to the second actuation assembly 150. Overall, the continuously variable extension of the second actuation assembly 150 allows for automatic adjustments based on a variety of environmental conditions.

Because the motor of the second actuation assembly 150 may require a longer response or uptake time to receive the signal and move to the disconnected state or second position, the controller 160 may send a motor signal to the second actuation assembly 150 at one time and then send a piezo signal to the first actuation assembly 140 at a second, delayed time. The result may be that each of the first actuation assembly 140 and the second actuation assembly 150 move at the same time.

FIG. 1B shows an example operation of the system 100a of FIG. 1A. In the example shown in FIG. 1B, system 100a is shown only with one side of the fast mechanical switch, including the first contact structure 120; the second contact structure 130 is omitted from the diagram. FIG. 1B also provides bounding boxes to draw attention to the movable component of the system (including the first actuation assembly 140 and the second actuation assembly 150) as well as the contact subassembly (including the first contact structure 120).

FIG. 1B also provides a graph 139 describing the location of the first contact structure 120 and the relationship between the actuation assemblies at various states/positions. For example, the first position 141a of the first contact structure 120 is shown at an initial point of contact with the second contact structure 130. At that first position 141a, (i) a first length 141b is shown corresponding to the expanded length of the piezoelectric actuation stack of the first actuation assembly 140, and (ii) a second length 141c is shown corresponding to the expanded length of the second actuation assembly 150 with the motor and connecting member 152. Then, a second position is shown wherein the system 100b has moved to the disconnected state to form the gap 170 between the first actuation assembly 140 and the second actuation assembly 150. In the second position 141d, (i) a third length 141e is shown corresponding to the contracted length of the first actuation assembly 140, and (ii) a fourth length 141f is shown corresponding to the contracted length of the second actuation assembly 150. The omitted second contact structure 130 can also move from an initial position 143a to a third position 143b.

Indeed, the piezoelectric actuator (e.g., of assembly 140) can respond within several hundreds of a microsecond, while, at the same time, the slower second mechanical actuator 150 (e.g., stepper motor) can operate faster actuator to enlarge the gap distance between the two contact plates, effectively increasing the basic impulse level to more than 100 kV within 1 to 2 seconds, as observed in certain configurations. The ultrafast disconnect/transfer operation can be made straightforward (few moving components) and compact while operating without high energy requirements or loss. The placement of the piezoelectric actuator (e.g., of assembly 140) and second mechanical actuator 150 (e.g., stepper motor) along the longitudinal axis 121 allows for more straightforward calibration and adjustments for thermal expansion compensation or contraction.

Example #2. FIG. 1C shows a second configuration for the dual actuation fast mechanical switch 100 (shown 100c), substantially similar to the system 100 a of FIG. 1A, in which the two actuator assemblies (140, 150) are located on the same side. In the example shown in FIG. 1C, the system 100c is shown in the connected state in which the first contact structure 120 is in the first position contacting the second contact structure 130. Example voltage/current flow are shown via arrows 147. In other configurations, the current flow can be in the reversed direction shown.

The example of FIG. 1C also shows the system 100c configured with a static mounting block 138 that is coupled to the second contact structure 130 and has electrical connection points (shown as 136a and 136b) to the second electrical terminal 134. In some implementations, the mounting block 138 is connected directly to the second electrical terminal 134.

To move from the connected state to the disconnected state via the disconnect action, the piezoelectric actuators of the first actuation assembly 140 will contract, as indicated by the arrows 145a in system 100c. Concurrent with the first actuation assembly 140, the motor of the second actuation assembly 150 will actuate to draw the connecting member 152 to contract, as indicated by arrows 145b. The result is the movement of the first contact structure 120 away from the second contact structure 130, as indicated by the arrow 145c.

Example #3. FIG. 1D shows a third configuration of the dual actuation fast mechanical switch 100 (shown as 100d), substantially similar to the system 100a of FIG. 1A, in which the piezoelectric actuation stack includes two or more arrays of piezoelectric devices. In the example shown in FIG. 1D, the first actuation assembly 140 (shown as 140a) includes two distinct piezoelectric stacks 142 and 144. Each of the piezoelectric stacks 142, 144 are separately coupled to the second insulating member 124 of the first contact structure 120. Each of the piezoelectric stacks 142, 144 is configured to simultaneously contract and expand, in concert with one another, to move the contact structure 120 between the first and second positions. In other implementations, more than two piezoelectric stacks may be provided for the first actuation assembly. Additionally, in yet other implementations, the second actuation assembly may be replaced with one or more piezoelectric stacks.

Example #4. FIG. 1E shows a fourth configuration of the dual actuation fast mechanical switch 100 (shown as 100e), substantially similar to the system 100a of FIG. 1A, in which switch 100e includes two sets of piezoelectric actuator assemblies 140, 180, one for each side of the contacts 120, 130. In the example shown in FIG. 1E, the second contact structure 130 is a movable contact structure, similar to the first contact structure 120. A second conductive structure 174 is shown, similar to the first conductive structure 102 on the opposite side of the system 100e. The second conductive structure 174 defines an inner cavity 176 with an opening 178 (e.g., circular opening) sized to accommodate the second contact structure 130 therein. The second contact structure 130 is slidably and electrically coupled to the second conductive structure 174.

In the example shown in FIG. 1E, the third actuation assembly 180 is disposed within the inner cavity 176 coupled to the second contact structure 130 and the mounting block 138 via insulating members 182 and 184 on each side. The third actuation assembly 180 is a piezoelectric actuation stack, which could be similar or distinct to the first actuation assembly 140 (e.g., same or different piezoelectric device, same or different number of devices in the stack). The controller 160 is also coupled to the third actuation assembly 180 to control the piezoelectric actuation stack. The controller 160, via its output signal, can energize or de-energize the piezoelectric actuators of the third actuation assembly 180 to expand or contract in length. The expansion or contraction of the third actuation assembly 180 moves the second contact structure 130 between a third and fourth position along the second longitudinal axis 131.

The first contact structure 120 and second contact structure 130 of system 100e form opposing pistons with their respective longitudinal axes aligned colinearly. In the connected state, (i) the first contact structure 120 is at the first position with each element of the first actuation assembly 140 fully extended, and (ii) the second contact structure 130 is at the third position with the third actuation assembly 180 fully extended. Upon initiation and receipt of a disconnect signal, the system 100e will move to the disconnected state wherein (i) the first contact structure 120 is in the second position with each element of the first actuation assembly 140 fully retracted, and (ii) the second contact structure 130 is at the fourth position with the third actuation assembly 180 fully retracted, forming a gap 170 between the distally located contact protrusion 122 and the distally located contact protrusion 132. The gap 170 in system 100e may be larger than the system 100a due to the addition of a third actuation assembly 180 and may be formed more quickly with the addition of an additional piezoelectric actuation stack.

Example #5. FIG. 1F shows a fifth configuration of the dual actuation fast mechanical switch 100 (shown as 100f), substantially similar to system 100e in FIG. 1E, in which two identical piezoelectric-driven pistons are implemented. In the example shown in FIG. 1F, the first actuation assembly 140 is the actuation assembly coupled to the first contact structure 120, and the third actuation assembly 180 (or the second actuation assembly of FIG. 1F) is the actuation assembly coupled to the second contact structure 130. Each of the first actuation assembly 140 and the third actuation assembly 180 are piezoelectric actuator stacks configured to expand and contract in response to a signal received from the controller 160.

Example #6. FIG. 1G shows a sixth configuration of the dual actuation fast mechanical switch 100 (shown as 100g), substantially similar to system 100e of FIG. 1E, in which the piezoelectric actuator stack 180 and the second actuator assembly 150 are located on different side of the switch, for different pistons 120, 130. In the example shown in FIG. 1G, the second actuation assembly 150 containing the motor is the only actuation assembly coupled to the first contact structure 120, and the third actuation assembly 180 is the only actuation assembly coupled to the second contact structure 130.

Heat Exchanger. It is contemplated that for other implementations of FIGS. 1A-1G, any one of the systems 100a-100g may further include a heat exchange system. Such a heat exchange system may be implemented that includes, e.g., a pipe or conduit (e.g., a copper pipe) disposed partially within the first conductive structure 102 and partially outside of the first conductive structure 102, or housing/vessel 103, via a heat exchanger opening defined by a sidewall of the first conductive structure 102 or the housing/vessel 103. A heat exchange system may further include a pump in fluid communication with the pipe or conduit, the pump configured to move a control fluid (e.g., water) through the pipe between a heat exchanger and the first conductive structure 102.

In other implementations, any one of the systems 100a-100g may further include an outer housing 103 that surrounds the first contact structure 120 and the second contact structure 130. The outer housing 103 may be an enclosed vessel surrounding each of the first contact structure 120, the second contact structure 130, the first conductive structure 102, and, in some implementations, the second conductive structure 174. The outer housing 103 may include an insulative material (e.g., ceramic or composite material). The outer housing 103 may enclose a dielectric fluid (e.g., a supercritical fluid as a dielectric medium) in an inner cavity of the outer housing containing the first and second contact structures. The outer housing may include welded seams or bolts extending through a side portion to seal a supercritical fluid within the inner cavity of the outer housing.

### Example Method of Operation

Disclosed herein are devices, systems, and methods for disconnecting two electrical terminals-for example, two high-voltage terminals of a DC power transmission station. In a normal operation, the disconnection of two high-voltage terminals may result in arcing between the two contact points. Arcing may occur when two contact points are separated by an insufficient distance, are separated at a time when a large voltage potential difference exists between the two contact points, or a combination of both. To sufficiently disconnect the two high-voltage terminals, the devices, systems, and methods disclosed herein provide for a fast disconnect at a point in time where the voltage potential difference is minimal. Furthermore, the devices, systems, and methods disclosed provide for an adequate separation distance between the two contact points. The system 100a shown in FIG. 1A may be used to describe an example method of operation.

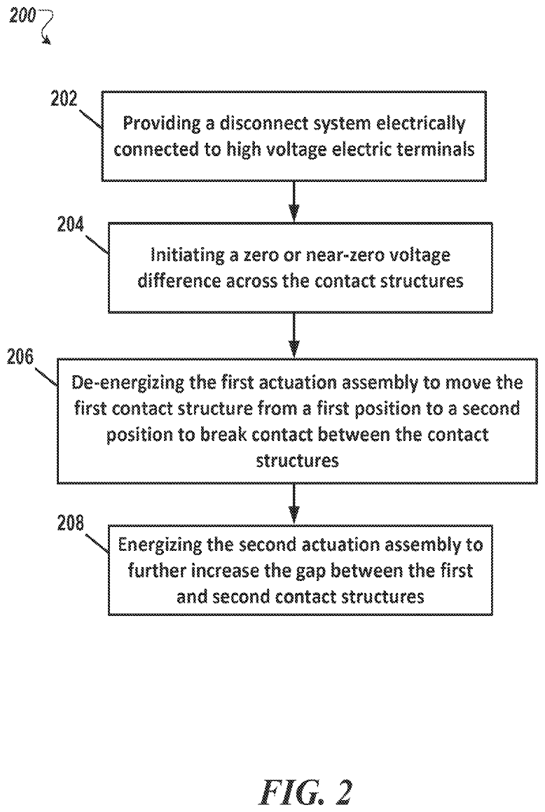

FIG. 2 provides a block diagram showing a method 200 of operation of a device or system of the present disclosure. First, at step 202, a disconnect system is provided (e.g., system 100a of FIG. 1A) electrically connected to high voltage electrical terminals (e.g., first electrical terminal 104 and second electrical terminal 134). When in the connected state, the first contact structure 120 is in the first position such that the contact protrusion 122 is in contact with the contact protrusion 132. In the connected state, the first actuation assembly 140 (the piezoelectric actuator stack) is energized to an expanded state, and the second actuation assembly 150 (the motor with connecting member 152) is energized to an extended state.

Next, at step 204, the method includes initiating a zero or near-zero voltage potential difference across the first contact structure 120 and the second contact structure 130. Such a 0V state might be detected by a controller (e.g., controller 160), for example, when an AC current crosses to a 0V position. In other implementations, the 0V state may be initiated by some other electrical component of the system.

Next, at step 206, the first actuation assembly 140 is de-energized to move the first contact structure 120 from a first position to a second position to break contact between the contact protrusion 122 and the contact protrusion 132. Once the first actuation assembly 140 is de-energized, the piezoelectric actuators may each contract to reduce the overall length of the first actuation assembly 140, moving the distally located contact protrusion 122 a small distance away from the distally located contact protrusion 132 and creating a separation distance or gap 170.

Next, at step 208, the second actuation assembly 150 is energized (e.g., to a second polarity) to reduce the overall length of the second actuation assembly 150 (e.g., by contracting or retracting the connecting member 152, which may be the shaft of the motor). Step 208 may occur concurrently with step 206. Once the second actuation assembly 150 retracts the connecting member 152, the separation distance or gap between the contact protrusions 122, 132 increases to a point that can avoid arcing.

### Example #1 Disconnect/Transfer System With Dual Actuation Fast Mechanical Switch

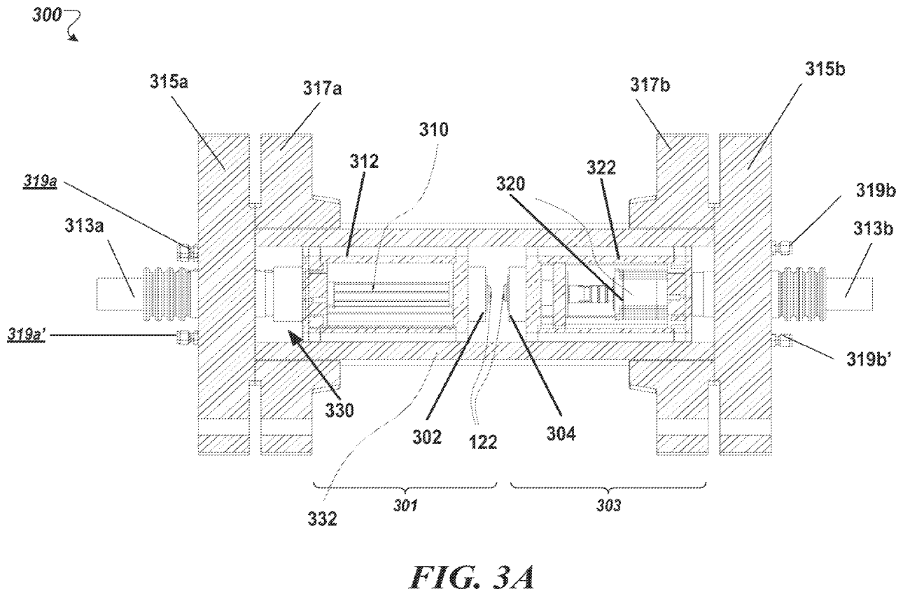

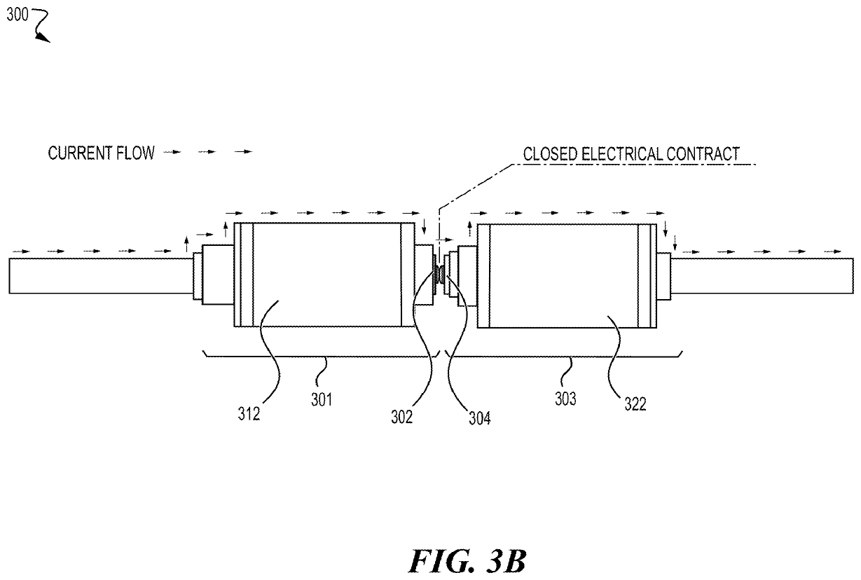

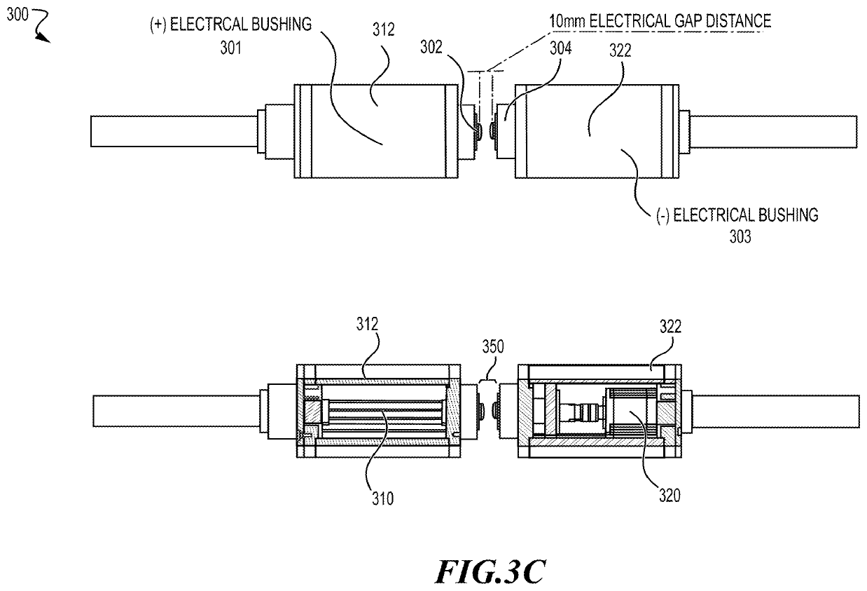

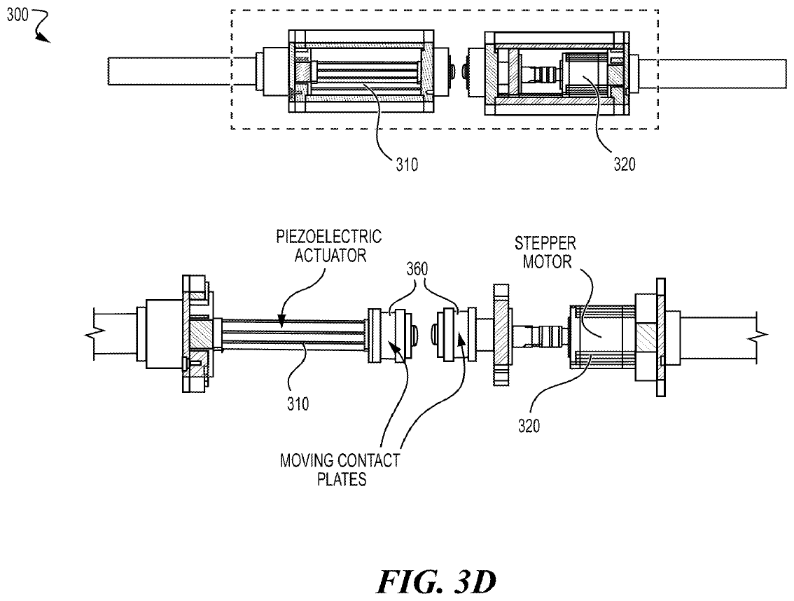

FIGS. 3A-3D show a first example of a disconnect or transfer switch 300 that employs the dual actuation fast mechanical switch (e.g., 100a-100g), according to another implementation. The disconnect or transfer switch (e.g., 300, 400) may be employed in a switchgear that includes electrical disconnect switches, fuses, and/or circuit breakers to control, protect, and/or isolate electrical equipment.

In the example shown in FIG. 3A, the disconnect or transfer switch 300 includes (i) a first actuation assembly 140 (shown as 310) comprising a piezoelectric actuator stack and (ii) a second actuation assembly 150 (shown as 320) comprising a stepper motor (e.g., similar to the second actuation assembly 150 of FIG. 1A) in two assembles 301, 303. The first contact structure 120 (shown as 302) is movable via the first actuation assembly 310 and a second contact structure 130 (shown as 304) is movable via the second actuation assembly 320.

Each of the first actuation assembly 310 and the second actuation assembly 320 are disposed within a high-pressure cavity 330 defined by an outer housing 103 (shown as 332). The outer housing 332 may comprise an insulative material that is electrically grounded. The high-pressure cavity 330 may contain a supercritical dielectric fluid.

Each of the first actuation assembly 310 and the second actuation assembly 320 include an outer conductive structure 312, 322 (e.g., an electrical bushing) configured to carry the current flow from high voltage connections on either side of the system 300 to the contact structures 302, 304 to connect to one another through the contacts while electrically isolating (e.g., via insulators on either side of the conductive structure) internal components comprising the respective actuation assembly. The electrical bushing 312, 322 each connects to a bus 313a, 313b that is fixably retained, and sealed within, the mounting blocks 108 (shown as 315a, 315b). In the example shown in FIG. 3A, the mounting blocks 315a, 315b is coupled to second mounting block 317a, 317b that retains the housing vessel.

Each of the first actuation assembly 310 and the second actuation assembly 320 form an opposing piston system in which the piezoelectric actuator stack can retract concurrently with the stepper motor to break the contact between the contact structures 302, 304 and extend that contact to an adequate distance to prevent arcing.

In the example shown in FIG. 3B, the inner moving portions of the system 300 comprising the two assembles 301, 303 is shown in an electrically connected state with some elements removed for clarity. Specifically, FIG. 3B shows the current flow from one side of the system 300 (i.e., one high-voltage electrical terminal) to the other side. The current flows into the system, around the outer conductive structure 312, through the first contact structure 302, through the second contact structure 304, around the outer conductive structure 322, and out to the other high voltage electrical terminal. The electrical flow (high voltage and high current) only flow on the exterior of the outer conductive structure 312, 322 and not to the internal actuating components located therein.

The mounting blocks 315a, 315b additionally include terminals 319a, 319b that provide control signals to, and electrically couples, respectively, the piezoelectric actuator stack of the first actuation assembly 310 and the motor of the second actuation assembly 320. The terminal 319a and 319a′ form, for assembly 310, the positive and negative terminals to connect in parallel to the multiple of piezoelectric device in the stack. The terminal 319b and 319b′ form, for assembly 320, the positive and negative terminals to connect in to the multiple of piezoelectric device in the stack. In some embodiments, the terminal 319b may be for a single-phase motor, multiple motors (e.g., 3-phase), etc.

FIG. 3C shows the internal views of the inner moving portions of the system 300 comprising the two assembles 301, 303. In the example shown in FIG. 3C, a gap 350 is shown between the first and second contact structures 302, 304.

FIG. 3D shows the internal views of the inner moving portions of the system 300, with the bushing structure not shown. As shown in the example of FIG. 3D, each of the first and second contact structures 302, 304 includes a seat 360 for a sealing member (e.g., an O-ring) to ensure the actuation assemblies are sufficiently insulated from the conductive structures and any dielectric fluid sealed therein.

### Example #2 Disconnect/Transfer System With Dual Actuation Fast Mechanical Switch

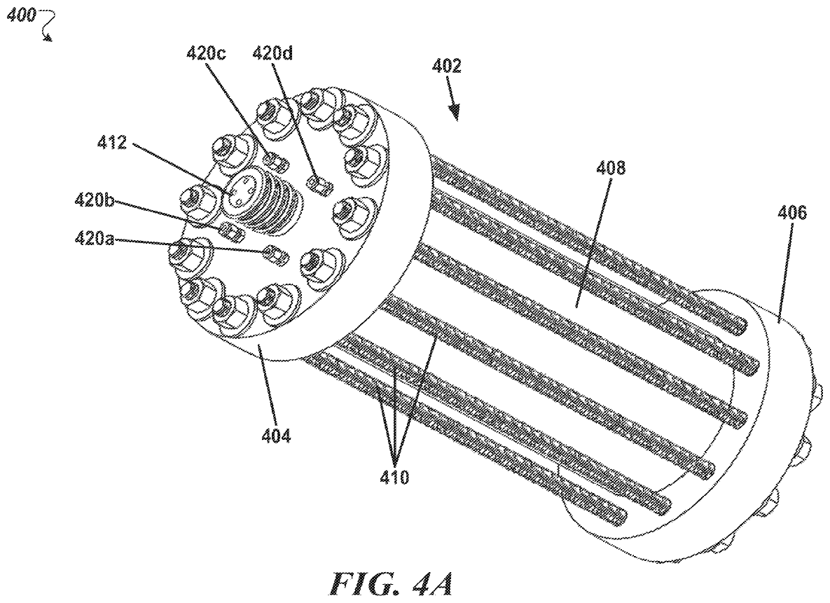

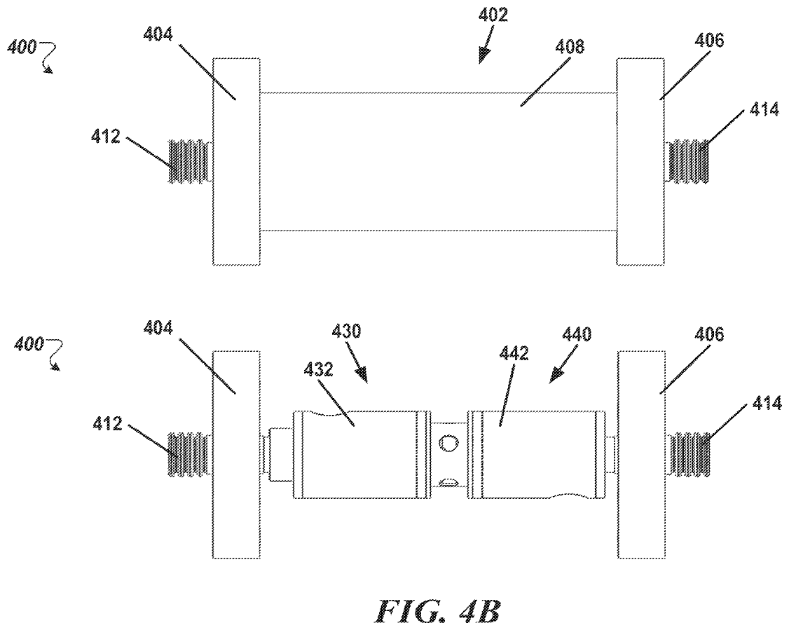

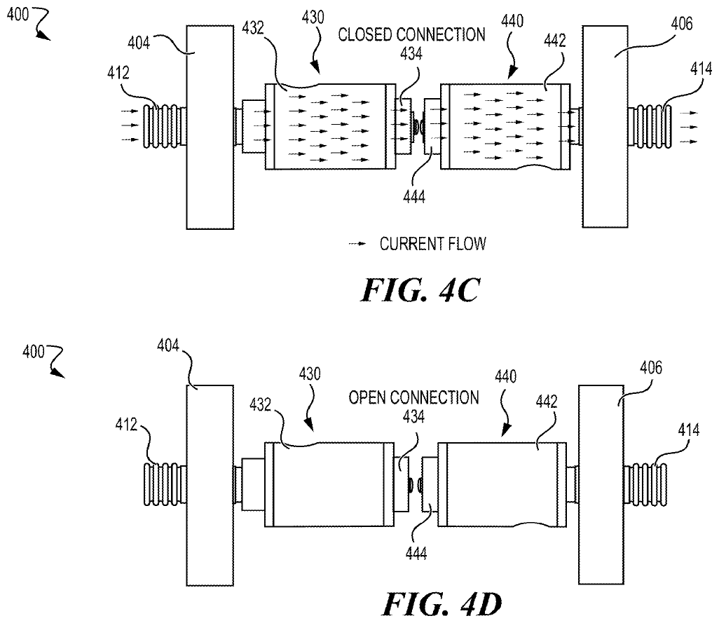

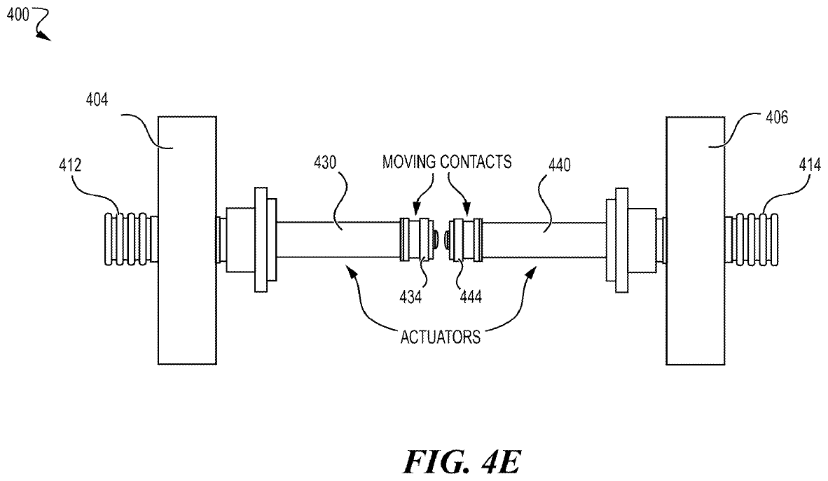

FIGS. 4A-4E show a second example of a disconnect or transfer switch 400 that employs the dual actuation fast mechanical switch (e.g., 100a-100g), according to another implementation. In the example shown in FIG. 4A, the system 400 includes an outer housing 402 having a first side 404 and a second side 406. A sidewall 408 extends from the first side 404 to the second side 406. A series of bolts 410 couples the first side 404 and the second side 406 to each other.

A first electrical terminal 412 (e.g., high voltage terminal connection) extends through the first side 404 of the outer housing 402. A second electrical terminal 414 extends through the second side 406 of the outer housing 402.

The system 400 further includes electrical terminals 319a (shown as four terminals 420a, 420b, 420c, and 420d) extending through the first side 404 of the outer housing 402. The electrical terminals are coupled to the actuation assemblies housed within the outer housing 402 and configured to send signals to activate/deactivate the actuation assemblies. For example, the electrical terminals 420a and 420b may form a first pair of connections coupled to a first piezoelectric stack, and the electrical terminals 420c and 420d may form a second pair of connections coupled to a second piezoelectric stack.

FIG. 4B shows a side view of the system 400 with the sidewall 408 and without the sidewall 408. A first actuation assembly 430 and a second actuation assembly 440 are disposed within the cavity defined by the outer housing 402.

As shown in FIGS. 4C, 4D, and 4E, the system 400 is similar to the system 100g of FIG. 1G in that each of the actuation assemblies 430, 440 are piezoelectric actuation stacks. The first actuation assembly 430 includes a first conductive structure 432 coupled to and in electrical communication with a movable first contact structure 434. Similarly, the second actuation assembly 440 includes a second conductive structure 442 coupled to and in electrical communication with a movable second contact structure 444.

The piezoelectric actuation stacks of each actuation assembly are configured to receive a signal via the four electrical terminals 420a-420d to either expand or contract in length. Upon expansion, the first contact structure 434 and the second contact structure 444 are in mechanical and electrical contact to allow current to flow from the first electrical terminal 313a (shown as 412), through the first conductive structure 432, through the first contact structure 434, through the second contact structure 444, through the second conductive structure 442, and finally outwards via the second electrical terminal 414. This current flow pattern is shown in FIG. 4C when the system 400 is in the closed or connected state.

In the unconnected or open state, shown in FIG. 4D, the piezoelectric actuation stacks receive a signal to contract, moving the first contact structure 434 and the second contact structure 444 away from each other. Once disconnected and moved away from each other, the first contact structure 434 and the second contact structure 444 define a gap 450, preventing current flow between the first electrical terminal 412 and the second electrical terminal 414.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

1. A system comprising:
a first conductive structure electrically connected to a first electrical terminal to receive high current and high voltage;
a first movable contact structure moveably connected to the first conductive structure and configured to move between a first position and a second position each in relation to the first conductive structure while in electrical contact with the first conductive structure;
a second contact structure electrically connected to a second electrical terminal configured to handle high current and high voltage, wherein the first movable contact structure is in contact with the second contact structure when in the first position, and wherein the first movable contact structure is disconnected from the second contact structure when in the second position;
a first actuation assembly disposed within the first conductive structure and mechanically coupled to the first movable contact structure to move the first movable contact structure, along a first direction, between the first position and the second position when energized or deenergized, respectively, to connect or disconnect the first movable contact structure to the second contact structure; and
a second actuation assembly either (i) mechanically coupled to the first actuation assembly within the first conductive structure to concurrently move the first movable contact structure from the first position to the second position, or (ii) mechanically coupled to the second contact structure within a second conductive structure to concurrently move the second contact structure to a third position further away from the first movable contact structure.

2. The system of claim 1, wherein the first actuation assembly moves the first movable contact structure to the first position when energized, and the first actuation assembly moves the first movable contact structure from the first position to the second position to break contact with the second contact structure when de-energized.

3. The system of claim 1, wherein the second actuation assembly is disposed within the first conductive structure and is mechanically coupled to the first actuation assembly, wherein the second actuation assembly moves the first movable contact structure in part from the first position to the second position.

4. The system of claim 1, wherein the second actuation assembly is disposed within the second conductive structure and moves the second contact structure to the third position, to further extend a separation distance between the first movable contact structure and the second contact structure.

5. The system of claim 4, wherein the second actuation assembly moves the second contact structure in response to a thermal expansion to (i) ensure adequate electrical connection between the first and second contact structures in the first position, and (ii) ensure an adequate separation distance between the first and second contact structures in the second and third positions.

6. The system of claim 1, wherein the first actuation assembly has a first longitudinal axis corresponding to the first direction, wherein the second actuation assembly has a second longitudinal axis colinear to the first longitudinal axis.

7. The system of claim 1, wherein a separation distance between the first movable contact structure and the second contact structure provides insulation of at least 100 kV.

8. The system of claim 1, further comprising:
an outer housing that surrounds the first movable contact structure and the second contact structure,
wherein the outer housing is an enclosed vessel to surround the first conductive structure, the first movable contact structure, and the second contact structure and enclose a dielectric fluid.

9. The system of claim 8, wherein the outer housing comprises an insulative material.

10. The system of claim 8, wherein the outer housing is a pressure vessel configured to house supercritical fluids as a dielectric medium.

11. The system of claim 3, further comprising:
a third actuation assembly located in the second conductive structure, the third actuation assembly coupled to the second contact structure.

12. The system of claim 1, wherein the first and second contact structures together form an opposing piston arrangement.

13. The system of claim 1, wherein the first actuation assembly comprises a plurality of piezoelectric devices arranged in at least one stack and, wherein the second actuation assembly comprises a servo motor, linear stepper motor, or a hydraulic system.

14. The system of claim 8, further comprising:
a heat exchange system comprising:
a pipe disposed partially within the outer housing and partially outside of the outer housing via a heat exchanger opening defined by a sidewall of the outer housing;
a heat exchanger disposed adjacent to the outer housing; and
a pump in fluid communication with the pipe, the pump configured to move a control fluid through the pipe between the heat exchanger and the outer housing.

15. The system of claim 1, wherein a signal to de-energize the first actuation assembly to move the first movable contact structure from the first position to the second position to break contact with the second contact structure is triggered by a 0V or near-zero voltage condition across the first and second contact structures.

16. The system of claim 1, further comprising:
a controller coupled to the first and second actuation assemblies and configured to de-energize the first actuation assembly to move the first movable contact structure from the first position to the second position to break contact with the second contact structure,
wherein a signal for the controller to de-energize the first actuation assembly is triggered by a 0V or near-zero voltage condition across the first and second actuation assemblies.

17. The system of claim 16, wherein the controller energizes or de-energizes each of the first actuation assembly and the second actuation assembly concurrently based on the signal.

18. The system of claim 1, wherein the system is configured as an AC power circuit breaker or a DC power circuit breaker.

19. The system of claim 8, wherein the outer housing comprises one or both of (i) welded seams and (ii) bolts extending through a side portion of the outer housing to seal a supercritical fluid within an inner cavity defined by the outer housing.

20. (canceled)

21. A method of operating a disconnect switch, the method comprising:
providing a disconnect system comprising:
a first conductive structure electrically connected to a first electrical terminal to receive high current and high voltage;
a first movable contact structure movably connected to the first conductive structure and configured to move between a first position and a second position each in relation to the first conductive structure while in electrical contact with the first conductive structure;
a second contact structure electrically connected to a second electrical terminal configured to handle high current and high voltage, wherein the first movable contact structure is in contact with the second contact structure in the first position and wherein the first movable contact structure is disconnected from the second contact structure when in the second position;
a first actuation assembly disposed within the first conductive structure and mechanically coupled to the first movable contact structure to move the first movable contact structure, along a first direction, between the first position and the second position when energized or deenergized, respectively, to connect or disconnect the first movable contact structure to the second contact structure; and
a second actuation assembly either (i) mechanically coupled to the first actuation assembly within the first conductive structure, or (ii) mechanically coupled to the second contact structure within a second conductive structure;
initiating a zero or near-zero voltage potential difference across the first and second contact structures;
de-energizing the first actuation assembly to move the first movable contact structure from the first position to the second position to break contact with the second contact structure; and
energizing the second actuation assembly to concurrently move either (i) the first movable contact structure from the first position to the second position to further extend a separation distance between the first movable contact structure and the second contact structure, or (ii) the second contact structure to a third position further away from the first movable contact structure.
